(19) United States
(12) Patent Application Publication
(10) Pub. No.: US 2003/0149650 A1
(43) Pub. Date: Aug. 7, 2003

(54) Financial transfer simulation system and method

(76) Inventors: Raymond T. Yeh, Austin, TX (US); Cornelius F.X. Kenney V, Alexandria, VA (US)

Correspondence Address: Michael C. Barrett, Fulbright & Jaworski L.L.P., Suite 2400, 600 Congress Avenue, Austin, TX, 78701, US

(21) Appl. No.: 10/256,383

(22) Filed: Sep. 27, 2002

Related U.S. Application Data
(63) Continuation-in-part of application No. 10/027,788, filed on Dec. 20, 2001.
(60) Provisional application No. 60/325,508, filed on Sep. 28, 2001.

(51) Int. Cl. G06F 17/60

(52) U.S. Cl. 705/35

(57) ABSTRACT

A financial transfer simulator program of the present invention provides an easy-to-use, visible, dynamic application for simulating a predefined set of financial transfers. The user can describe the set of financial transfers through graphical icons and simple input forms for parameters, without being concerned about how a financial transfer amount or stream of financial transfer amounts is calculated. The assumptions of the financial model are described explicitly in accessible, easily-changed graphical models, where the relationships between financial transfers are portrayed in terms of sequence, time, and flow of control. In one embodiment, a financial transfer simulator program is provided that is capable, when executed by a computer, of performing the following acts. Initially, it provides to a user a user interface for receiving a financial transfer model instance. It provides command options to the user to allow it to specify simulation parameters and edit the model instance. It also displays to the user results of the simulation upon request from the user.

This patent claims the benefit of, relies upon, and expressly incorporates by reference U.S. Provisional Patent App. No. 60/325,508, entitled “Financial Transfer Modeling System and Method,” filed on Sep. 28, 2001. It is also a continuation-in-part of U.S. patent application Ser. No. 10/027,788, entitled, “Financial Transfer Modeling System and Method,” filed Dec. 20, 2001, which is incorporated by reference into this specification.

### TECHNICAL FIELD OF THE INVENTION

The present invention generally relates to a method and system for modeling and simulating financial systems. In particular, the present invention relates to a financial transfer simulation program for simulating financial transfer models of financial products and systems.

### BACKGROUND

For many people the attributes of financial products are mysterious. Consumers, partners, and employees of financial services companies all display a lack of understanding of the behavior and composition of financial products. Many consumers cannot describe the benefits, features, or behaviors of financial products such as mortgages and credit cards. Partners of financial services companies, e.g., realtors and mortgage brokers, have difficulty perceiving and explaining differences between financial products. Employees of financial services companies often define the same product in different terms, which results in the inability of those companies to efficiently develop, analyze and test complicated financial products.

As is the case with experts in any discipline, people who are fluent in accounting assume that others understand their tools such as accounts and calculations. However, many well-educated adults are innumerate and cannot use these accounts or calculations. Misunderstandings are common because of the gap between those who are numerate and fluent in accounting and those who are not. Many powerful tools for describing accounts and calculations are available on computers, but these tools are aimed at the frequent, fluent users, who do not always need simple, easy-to-follow representations of their financial models. The prevailing assumption is that numeracy is a prerequisite for understanding these financial models, but many of the people for whom the models are developed are not numerate. The people who build accounting tools on computers are themselves numerate and design the user interfaces for numerate people.

Computer spreadsheet applications have been the preeminent financial modeling tool for over twenty years. Unfortunately, for users unfamiliar with the conventions of accounting, spreadsheets can be unintelligible and intimidating. Even more problematic, large or complex spreadsheets can be difficult to maintain because their logic is hidden in the formulae of the cells.

Applications for electronically processing financial transfers have been developed for specific products. However, they have tended to be limited in their applicability for other products, and they require users to separately become familiar with their user interfaces and logical methodologies. Moreover, the costs and time to build these applications has stayed high or become higher.

These practical problems associated with conventional modeling schemes also apply to corresponding simulation methods used for simulating the modeled financial products. While financial transfer models implemented in spreadsheets and software languages can be very powerful, their complexity makes experimentation in short cycles and thus model simulation more difficult for two reasons. The first is that the assumptions underlying the cashflow model are embedded in the spreadsheet formulae or in the software program procedures, instead of being explicit and easily changed without altering the structure of the rest of the financial transfer model. The second reason is that the information structures in the spreadsheet or software models may not match the structures used to implement those structures in actual financial processes.

Conventional simulation schemes have not been well suited for modeling and simulating the timing aspects in cashflow systems. The timing of cashflows is important because of the time value of money. A dollar today is worth more than a dollar a year from now, assuming positive interest rates. Except when inflation is high, cashflows are discounted, using an assumed interest rate, to calculate their imputed future value. The longer the time period, the greater the discount rate due to compounding. Compounding, or the growth in value of a cashflow based on interest payments on the principle amount and interest payments on the accumulated interest payments, is the driving dynamic in most investment calculations. Spreadsheet models can represent different time periods as columns, but there are practical limits to how small the time intervals in the spreadsheet can be without making the spreadsheet very large with many zero-value cells. The spreadsheet is an inefficient information structure for describing exactly when many cashflows occur; the spreadsheet is a great structure for summarizing flows that occurred in a reporting period such as a week, month, quarter, or year. Thus, spreadsheets and other similar conventional financial transfer simulation schemas are not well suited for simulating complex financial transfer models, especially over practical time durations with meaningfully small time increments for catching problematic behaviors.

Accordingly, what is need is an improved general scheme for simulating financial systems and products.

### SUMMARY OF THE INVENTION

A financial transfer simulator program of the present invention provides an easy-to-use, visible, dynamic application for simulating a predefined set of financial transfers. The user can describe the set of financial transfers through graphical icons and simple input forms for parameters, without being concerned about how a financial transfer amount or stream of financial transfer amounts is calculated. The assumptions of the financial model are described explicitly in accessible, easily-changed graphical models, where the relationships between financial transfers are portrayed in terms of sequence, time, and flow of control. In one embodiment, a financial transfer simulator program is provided that is capable, when executed by a computer, of performing the following acts. Initially, it provides to a user a user interface for receiving a financial transfer model instance. It provides command options to the user to allow him or her to specify simulation parameters and edit the model instance. It also displays to the user results of the simulation upon request from the user.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 shows an exemplary screen interface for one embodiment of a financial transfer modeling program.

FIG. 2A is a block diagram of a computer with a financial transfer modeling program.

FIG. 2B shows a block diagram of an object-oriented financial transfer modeling program.

FIG. 3A is an exemplary screen interface for one embodiment of a financial transfer simulator program of the present invention.

FIG. 3B is a block diagram showing a computer with one embodiment of a loaded financial transfer simulator program of the present invention.

FIG. 4 is a flow diagram of one embodiment of a financial transfer program routine of the present invention.

FIGS. 5A through 5M show exemplary screen interfaces for one embodiment of a financial transfer simulator program of the present invention.

FIGS. 6A through 6C show a financial transfer model and simulation results for an exemplary financial transfer model of the present invention.

### DETAILED DESCRIPTION

A. Financial Transfer Modeling Overview

The defining attributes of financial products can be determined by examining the movement of money and other financial transfers, between parties to the product. While the names and descriptions of products vary, the value, price, cost, and risk of a financial product are driven by the set of financial transfers defined by the product. The present invention provides a financial transfer simulator (“FTS”) program for simulating financial transfer models such as the type presented in U.S. patent application Ser. No. 10/027,788, filed Dec. 20, 2001, which has been incorporated by reference into this specification.

Financial transfer modeling and simulation can be useful in a variety of systems including financial product development, household and company budgeting, project investment preparation and evaluation, business modeling and planning, and financial analysis such as discounting and net present value analysis. Potential users of financial transfer modeling and simulation programs include financial analysts, product developers, computer application developers, and auditors. For context sake, a brief overview of a financial transfer modeling methodology for preparing financial transfer models is presented herein.

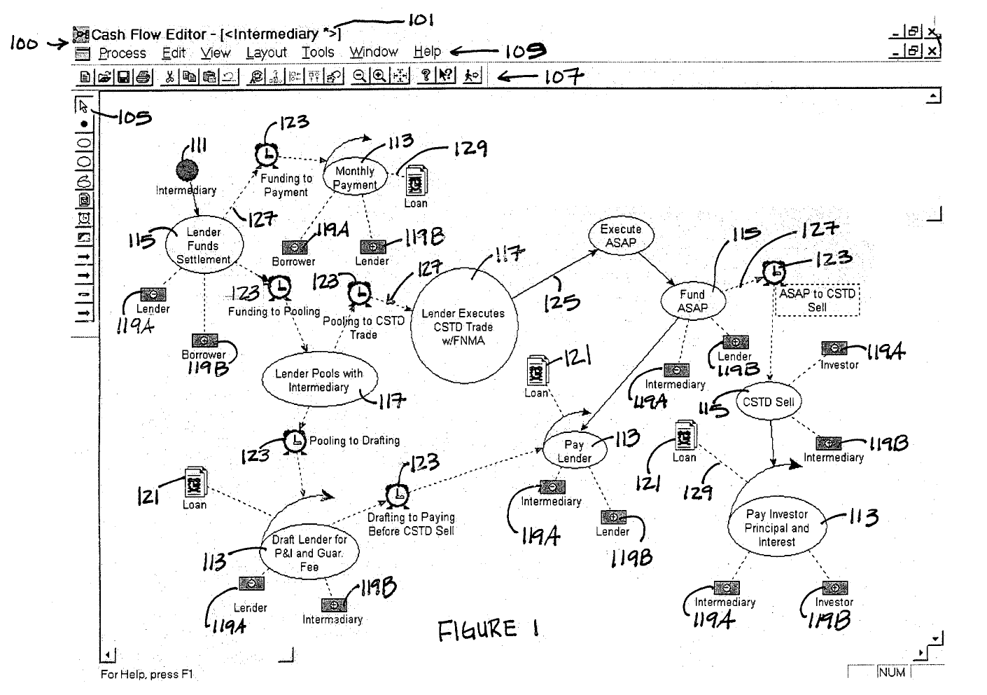

FIG. 1 shows the screen interface 100 for one embodiment of a financial transfer modeling program. The depicted screen shows an exemplary financial transfer model 101, entitled “Intermediary,” which corresponds to a mortgage banking product. The interface has tools, 105, 107 and menu commands 109 for allowing a user to create a desired financial transfer model such as the one depicted on the screen. The program provides a computer software tool that uses graphic icons 111-129 for representing the fundamental components of a financial product in terms of its financial transfers for building and efficiently modeling the product. These icons include a “start” icon 111, a recurring financial transfer activity icon 113, a non recurring financial transfer activity icon 115, a non financial transfer activity icon 117, financial transfer role icons 119 (payer 119A, payee 119B), a financial transfer activity schedule icon 121, and a time delay (or timer) icon 123. In one object oriented implementation, each icon has a corresponding predefined object from which object instances are created when a user creates a new icon instance on the screen. There are also different relationship connections including information flow connections 125, timer connections 127, association connections 129, and termination connections (not shown). Using these icons and connections (or relations), a user can create financial transfer models that describe a wide range of financial transactions such as payments, receipts, loans, investments, and trades.

The financial transfer activity icons (recurring financial transfer 113, non recurring financial transfer 115, non financial transfer 117), in cooperation with the role icons 119, provide simple, easy-to-remember shapes for efficiently representing financial transfer transactions that may be nested within larger, more complicated financial transfer products (or systems). Each account is under the control of one cash role, or entity, that appears in a financial transfer model. The financial transfer role icon serves as a graphical indicator of a logical file created and manipulated by the financial transfer model. The role icons 119 help users identify the account where a transaction originates and the account where the transaction ends without requiring knowledge of the underlying accounting procedures. For non-accountants or people working with complex financial transfer models, the financial transfer activity and role icons provide a way of efficiently conveying relevant information about a financial transfer product without overwhelming the user with complicated, convoluted graphics and excessive formulas and entries.

When two different instances of a financial transfer role icon are linked to an instance of a financial transfer activity icon, the user may define a transaction, determine the specific account for each instance of the financial transfer account icon, identify the account where the transaction originates and the account where the transaction ends, and conclude by describing how the transaction amount is to be calculated. The instance of the financial transfer role icon for the account where the transaction originates is then marked with a minus sign (role icons 119A), and the instance of the financial transfer role icon for the account where the transaction ends is marked with a plus sign (role icons 119B).

In operation, the user generally begins by launching the financial transfer modeling program, which loads the financial transfer editor drawing area and palettes. If the user is modifying an existing model, the model is retrieved from the computer hard disk storage and loaded into the financial transfer editor drawing editor. The user may choose to create a model, instead. The procedure is the same for modifying or creating a model. The user selects the icons, menus, and input screens to describe the financial transfers being modeled, and connects the activity and related other icons using the available connectors according to the predefined rules, which are enforced by the program's syntax-based structure.

For a one-time financial transfer (non recurring), the user supplies the from account, to account, amount, and duration of the transaction. For recurring financial transfers, the user supplies the from account, to account, duration of the transaction, and the user either provides parameters for calculating the financial transfers through simple input forms or defines the formula for calculating the financial transfers through a financial transfer formula editor. If the user defines a formula through the financial transfer formula editor, the editor checks the syntax of the formula and can generate a table showing the calculated financial transfer amounts and dates.

At any time or at the end of the user session, the user may invoke the completeness checker to perform additional tests of the validity of the financial transfer model. The user may store an updated version of the current financial transfer model at any time or at the end of the session. The user may also open additional financial transfer models at any time, and the user may cut-and-paste graphical elements from one model to another. Alternatively, the user may opt not to store changes made to a model since the last version was stored, or he/she may opt not to store a new model at all. At the end of the session, the user has the option of exiting without testing the validity of the open financial transfer model(s), but in the depicted embodiment, the user must pass a financial transfer model through the completeness checker to store a updated version of that model.

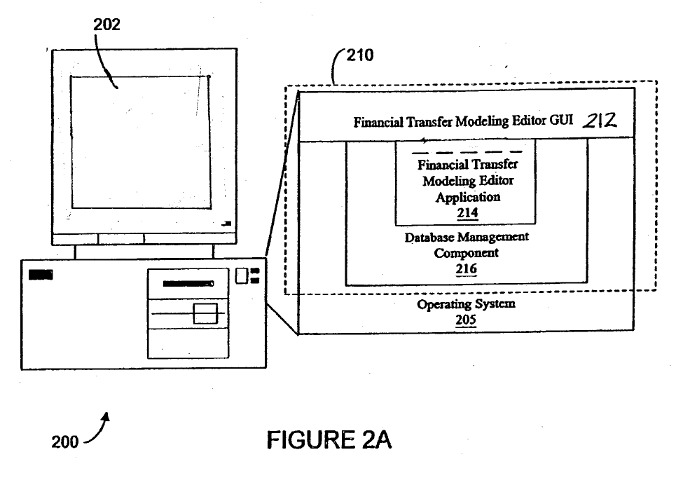

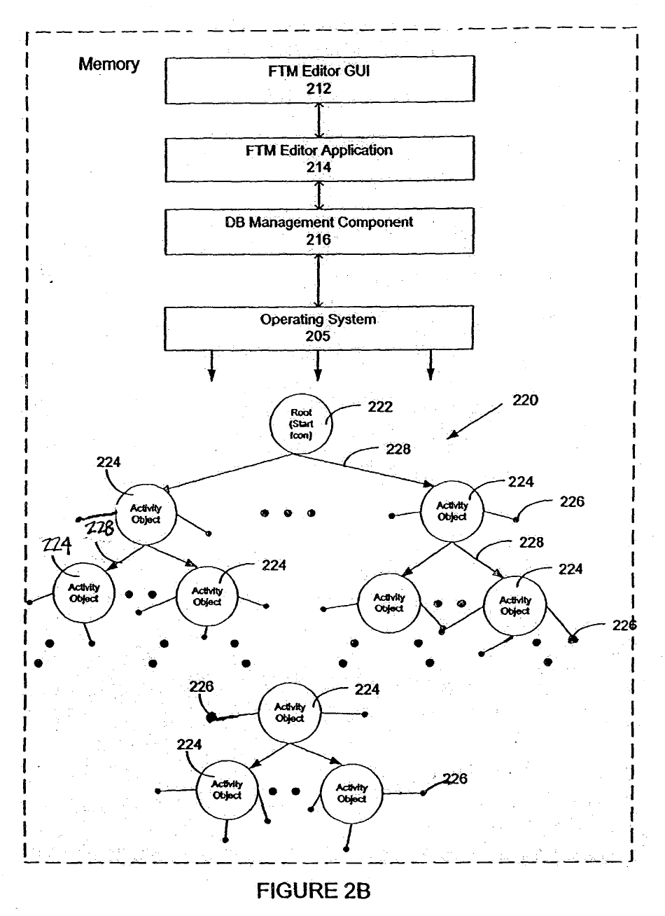

FIG. 2A shows a block diagram of one embodiment of a financial transfer modeling program 210. Financial transfer modeling program 210 is executed in a computer 200 with an operating system (“OS”) 205. The depicted financial transfer modeling program 210 generally includes a financial transfer modeling editor graphical user interface (“GUI”) component 212, a financial transfer modeling editor application component 214, and a database management component 216, all of which are operably linked to one another and execute within computer 200. When launched, the financial transfer modeling program 210 causes the computer to display a financial transfer editor interface screen 202. It also builds (or defines) a financial transfer model in response to commands from a user via the user interface component 212. As it is being built, a financial transfer model is both displayed on the screen, and defined in memory, e.g., as a financial transfer object model within an object container defined within database management component 216.

The computer 200 can be implemented with any suitable computer for executing the financial transfer modeling program 210. For example, it could be a personal computer, a mainframe computer, a server computer, an internet appliance executing a client-side script, and the like. Similarly, the operating system may be any suitable operating system such as a Unix, Sun Solaris, Macintosh, or Windows based operating system. In the depicted embodiment, a Windows-based personal computer is used.

The financial transfer modeling program components 212, 214 and 216 may be implemented and/or generated using any suitable programming architecture. For example, in one embodiment, an object-oriented based architecture is utilized. In this embodiment, the graphical user interface component 212 could be written in C++. The financial transfer editor application component 214 is also written using a suitable scheme such as C++, but any other suitable programming language such as Java, or Cobol, could also be used. With this object oriented architecture, the database management component 216 is implemented with an object management system (e.g., object-oriented database program) such as one provided by Versant Systems™. However, depending upon the particular architecture employed, any suitable database program such as a flat file, or hierarchical database program could be utilized. With an object based modeling scheme, however, an object oriented database program is likely to be most efficient when used for saving and retrieving model instances.

FIG. 2B shows a block depiction of one embodiment of a financial transfer modeling program as implemented in memory for building a financial transfer object model 220. The financial transfer editor application component 214 contains predefined object class and attribute specifications for each financial transfer modeling program icon type. It is encoded to define the object instances in a data structure (e.g., directed graph, binary tree, linked list) that is suitable for efficiently implementing the various tools and features (syntax checker, syntax based completeness checker, simulator) either included within the program or available for use on the model. When a user initiates a command to modify the displayed financial transfer model, the user interface component 212 translates the command to the application component 214, which causes the selected object instance to either be instantiated or modified. In the depicted embodiment, the database management component 216 is used as the memory management system for storing and organizing the financial transfer model 220 in memory via the operating system 205. Database components such as object oriented database programs are typically well suited for interfacing with the operating system 205 in order to manage memory operations.

The depicted financial transfer object model 220 is defined in a directed graph data structure. It includes a root object instance 222, along with one or more activity object instances 224 with their related “children” object instances 226. The activity objects are connected to one another through a directed relationship 228. The root object 222 corresponds to the start icon 111, and the activity objects correspond to the recurring financial transfer activity icons 113, non recurring financial transfer activity icons 115, non financial transfer activity icons 117, and the timer icons 123. Similarly, the related children objects 226 correspond to the financial transfer role icons 119 (payer 119A, payee 119B) and the financial transfer schedule icons 121. They also correspond to non-icon objects that help to further define a particular activity object instance. For example, financial transfer activity objects can have related “transaction” objects that define one or more transactions associated with the activity and its associated cash roles. However, in the depicted embodiment, transaction objects are defined via the user interface through the activity icon, itself, rather than through a separate icon to be attached to the activity icon.

Timer objects are part of the related children objects 226. They have one associated parent activity object 224 and one or more children activity objects 226, which can comprise other activity objects (that are to be delayed from earlier activities) or parameter objects for defining the particular time delay parameters of the timer object. The possible relationships 228 correspond to the information flow connectors, timer connectors, association connectors, and termination connectors.

B. Financial Transfer Simulator

Financial transfer simulators simulate financial transfer models. The models are typically syntactically correct (i.e., with no missing connections) and complete (i.e., with two or more cash roles assigned to each cash activity) before being simulated. In fact, in one embodiment, a financial transfer simulator program has a completeness check routine that determines if loaded models are complete before attempting to simulate them. Financial transfer simulation can be an important tool for financial transfer model designers, aiding their understanding of the defined process, serving as a process debugger, and providing a powerful means of illustrating and improving a financial system design.

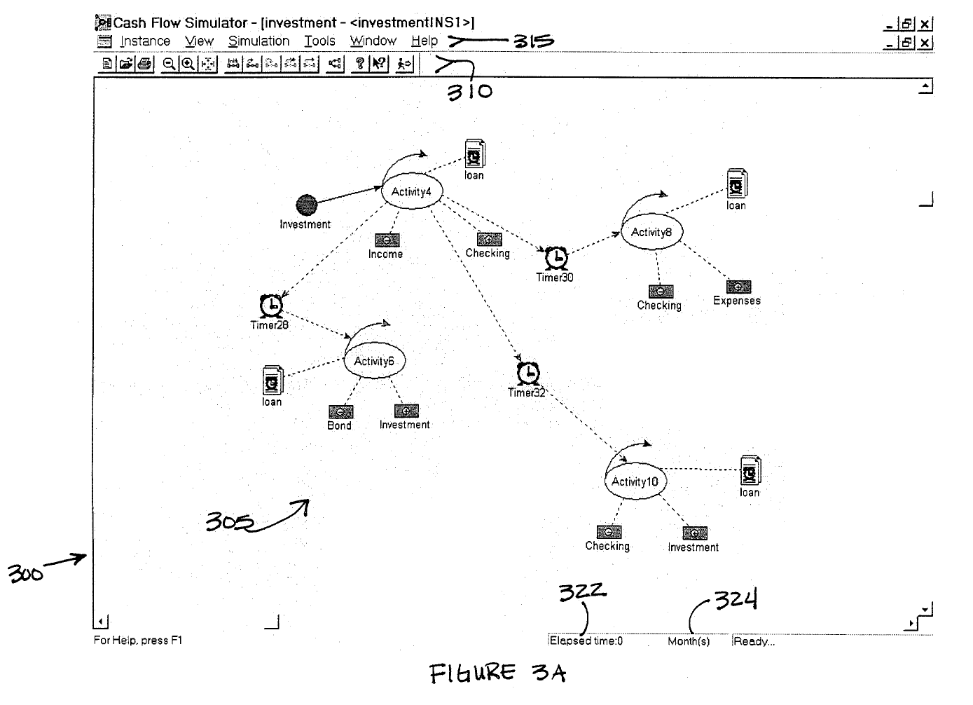

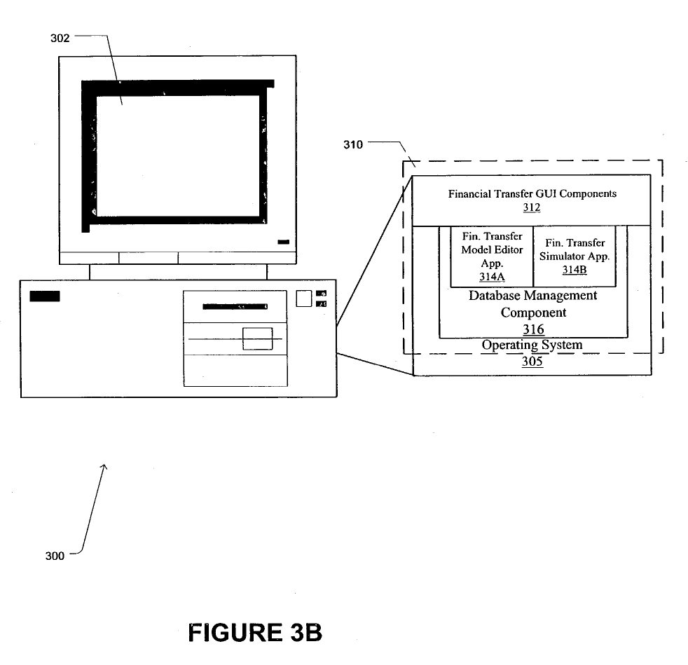

FIG. 3A shows screen interface 300 for one embodiment of a financial transfer simulator program of the present invention. A model instance 305 ([INS1>]) of an exemplary “investment” model is shown on the screen. The screen interface is similar to that of the financial transfer modeling program except that it has menus and tools for simulating and partially editing a model instance rather than for building and editing a model. Screen interface 300 generally has tools 310 and command menus 315 for manipulating and simulating a loaded model instance. It also has a status panel with parameters 322 and 324 for indicating the status of a simulation.

In the depicted embodiment, the financial transfer model icons (objects) affect simulation in the following ways. The starter icon serves as the starting point of a process simulation. When a process simulation is initiated, the start object activates subsequent activities and timers. (As used in this context, subsequent activities correspond to “child” objects that have an information flow, timer flow, or termination flow relationship with a parent activity that is activated.) During simulation, the timer is activated by a preceding starter icon or activity icon that has completed. After the delay time specified in the timer icon has passed, activities immediately subsequent to the timer are activated. Non recurring (cash, non-cash) activities are triggered (activated, fired) when preceding activities are completed or the preceding start or timer activates it. When a non recurring activity has completed, it will activate subsequent activities or timers. The simulation behavior for a recurring cash activity is similar to that of a non recurring cash activity except that after a recurring activity is fired, it is self-activated according to the policy (e.g., amortization schedule, payment schedule, cycle setting) that defines its activation schedule.

The policies may or may not have an impact on simulation behavior. For example, they can be configured to serve as dynamic variables used to affect other variables such as cash roles or transaction column values, or alternatively, they can be configured to serve as passive variables for tallying cash amounts based on simulated cash transactions defined within activated activities. The schedule object triggers recurring cash activities that are associated with it.

The connectors behave in the following way when simulated. The starter or activity at the beginning of an information flow activates the activity at the other end. The timer or activity at the upstream side of a terminate flow terminates the recurring activity at the other (downstream) end. The association connections have little impact on simulation behavior other than they indirectly connect schedules to reoccurring activities thereby allowing them to trigger the reoccurring activity, and they connect cash roles to cash activities, which affect the cash role values based on the state of an activity during simulation. The timer connection is used to connect a timer and an activity or a timer and a starter for timing control. During simulation, a pair of timer connections from an activity to a timer and from the timer to a subsequent activity indicates that the subsequent activity will begin after the specified delay time occurs from the end of the former activity.

1. Simulator Program

A simulator program may be configured using any suitable scheme. For example, with reference to FIG. 3B, in one embodiment, it may be implemented within a financial transfer suite 310 that includes financial transfer GUI components 312, a financial transfer modeling application 314A, a financial transfer simulator application 314B, and a database management component 316. In one embodiment, the editor and simulator applications (or components) are loaded in the computer's working memory, in essence, as a single application, but a separate user interface is used depending upon which component (314A or 314B) is in use. Alternatively, any suitable scheme an be implemented. For example, the applications can function as separate stand-alone applications or their components can be combined into a single application using a common screen interface that has all of the tools and menus required for implementing each application. Whatever the scheme, it is desirable for each application to have access to a common database management component 316. In this way, when a model instance is to be simulated, the simulator application 314B can efficiently read a copy of the model from the common database and store it into a suitable data structure for setting up and performing a discrete event simulation.

In one embodiment, the common database component 316 is implemented with an object oriented database application, and a separate data structure (e.g., database application such as Microsoft Access™) is used for performing the simulation. In this embodiment, the data structure could be a multi-dimensional array or set of records that are commonly linked (or indexed) by a time increment dimension that is incrementally sequenced by the simulator component 314B as it performs a discrete event simulation of the loaded financial transfer model instance. Each record (or separate array dimension) corresponds to a separate activity and/or object in the model. As the simulator component progresses through the designated simulation period, it activates each object that is to be activated at a given time increment, based on activity relationships, predefined parameters and other predicates associated with the object. In doing this, it updates cash role objects as dictated by the simulation for each time unit. In this way, a user can readily analyze and debug the defined cash flows as a function of time.

In the depicted embodiment, when the simulator application is executed, a user typically specifies the simulation parameters for a selected model instance. These parameters define the duration and time intervals used by a simulator to map cashflows and set how the simulation displays its actions through animating activities being evaluated and/or account detail being generated. Once an instance has been created, a user may change the numerical parameters in the instance. However, in one embodiment, the user may not change the actual structure of the model including adding or deleting icons or connections, and changing the placement of icons. In this embodiment, changes in simulation instances are not reflected in the editor model. This feature allows users to create multiple instances and simulate multiple “what-if” scenarios to test the impact of changes to the model. If the user has already created one or more instances of a model in the simulator, and then makes changes to the model in the editor, the simulator instances remain unaffected. If, however, the user creates additional instances in the simulator after changing the model in the editor, the new instance will reflect the most recent changes to the model.

The user could also set one or more breakpoints on one or more activities. At each breakpoint, the simulation would display a message identifying the current activity and pause until the user tells the simulation to resume or end.

Next, the user would typically start the simulation, which ends when the user-defined time period has been completed by the simulation or the user chooses to end the simulation by manually choosing a menu option. During this stage, the simulation animates activities as they are evaluated, if the user chose that option, and generates transactions for each occurrence of all the cashflows in the model that are within the time period of the simulation. Large models and/or models with many delays or long activity durations may include cashflows that do not occur within the time period of a simulation instance, particularly if the time period is short. The user may pause the simulation during this stage by manually selecting a menu option to determine which cashflows have occurred within the period completed by the simulator. The account detail outputs are available at any time for printing or saving in a text file or spreadsheet. For example, each account detail transaction could be stored as a row in a Microsoft Access™ data base table named for a role that owns that account.

Finally, the simulation session ends when the simulation has ended or the user stops the simulation. The simulator may produce a summary describing the simulated behavior of that instance of the model and wait for the next user action. The next user action could be closing the Cashflow Simulator, choosing another model to simulate, rerunning the current instance of the model with the same parameters, rerunning the same instance of the model with different parameters, or creating a new instance of the model.

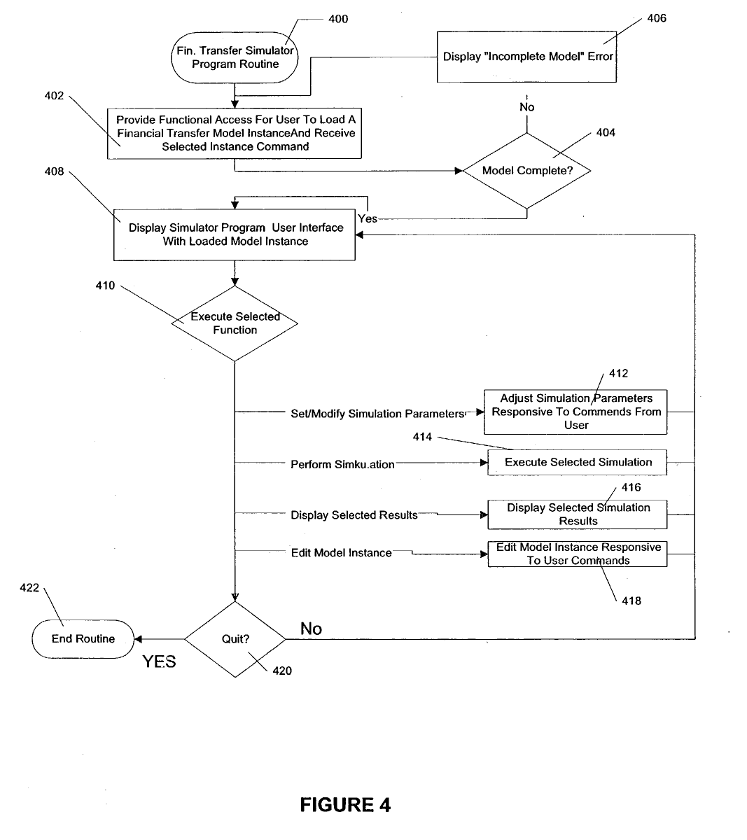

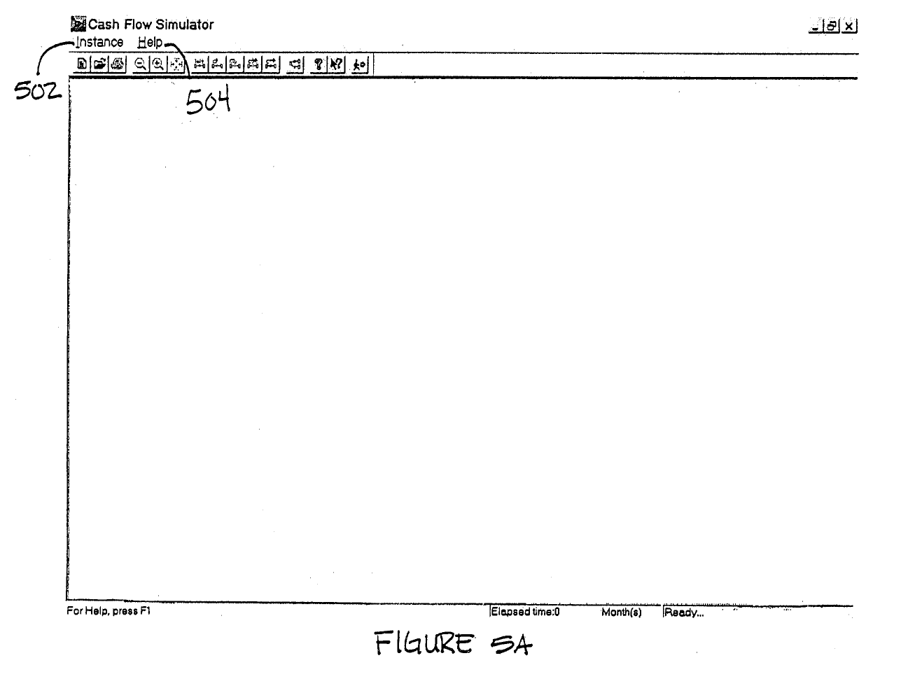

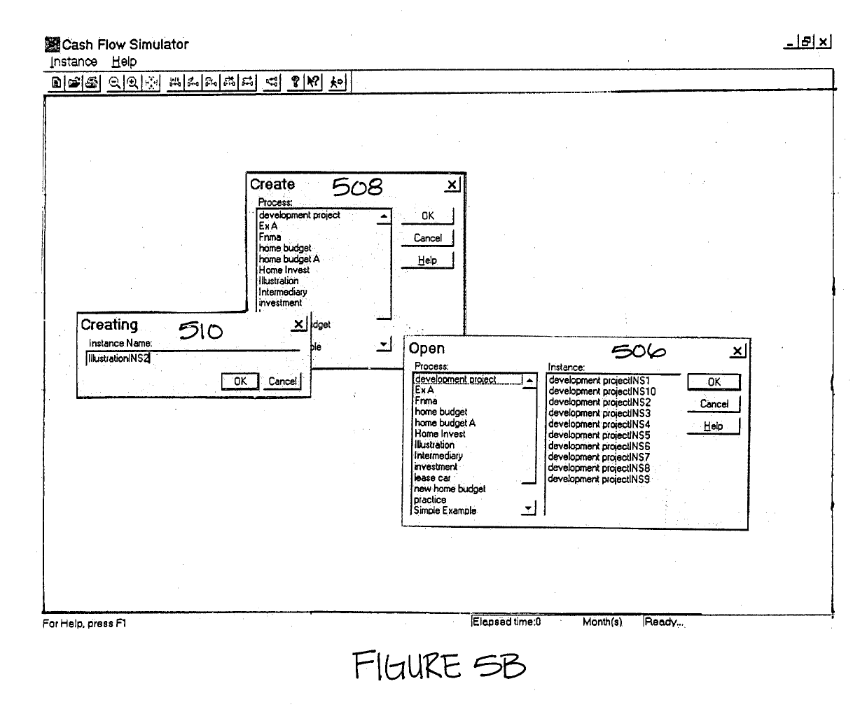

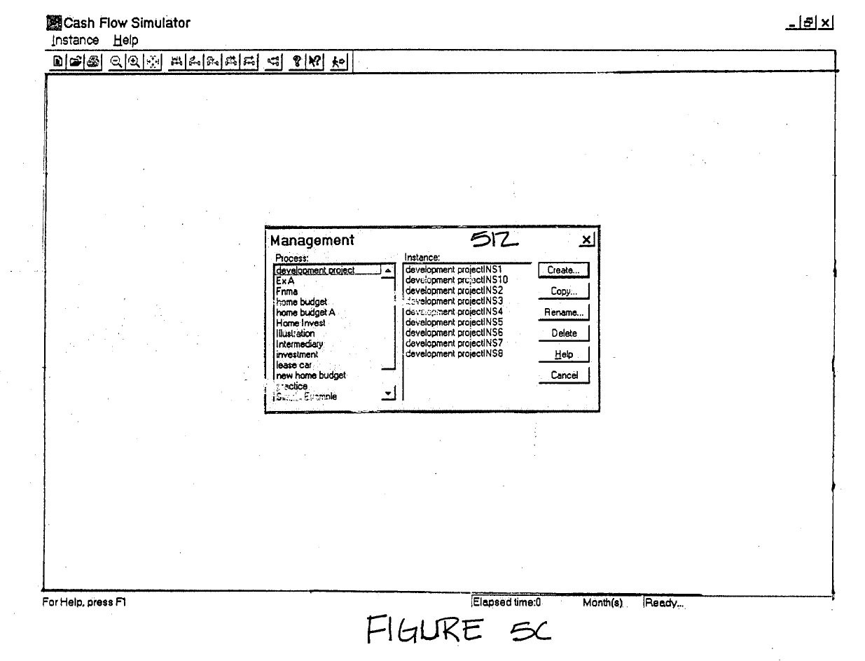

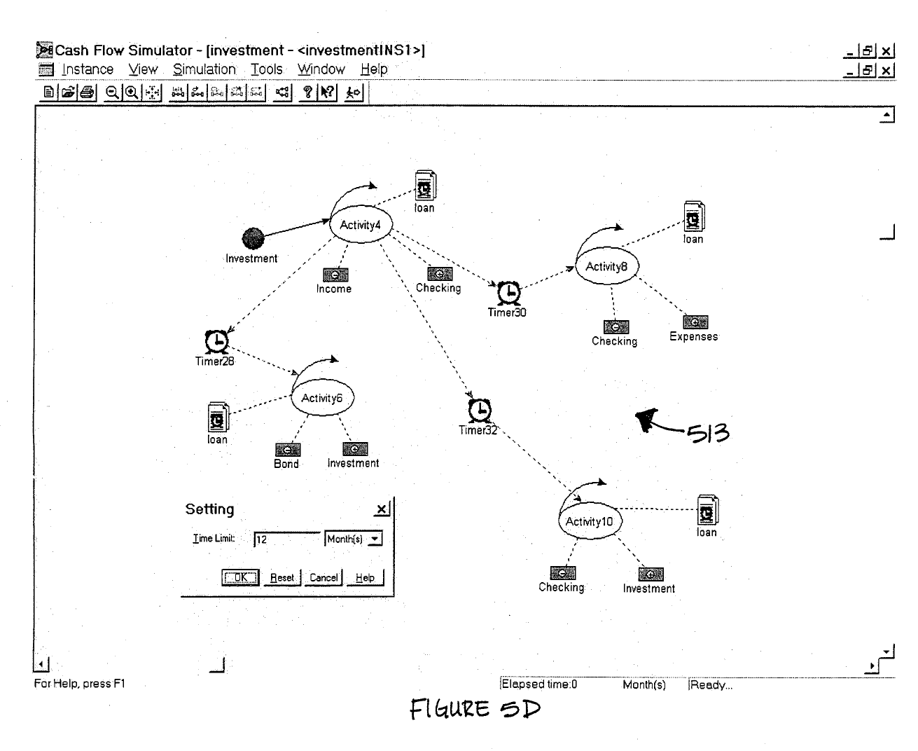

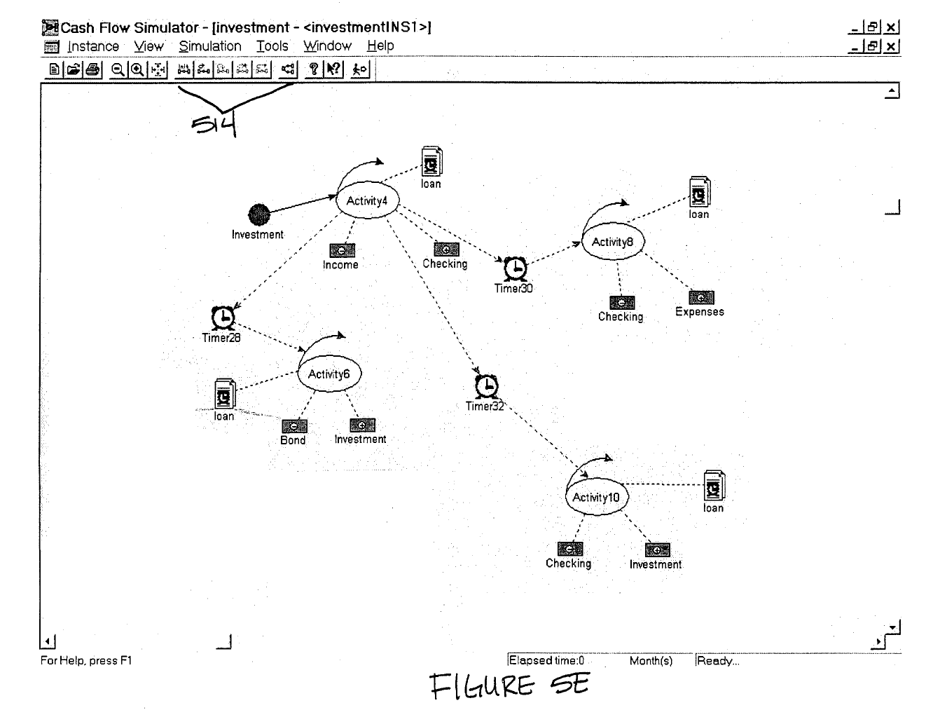

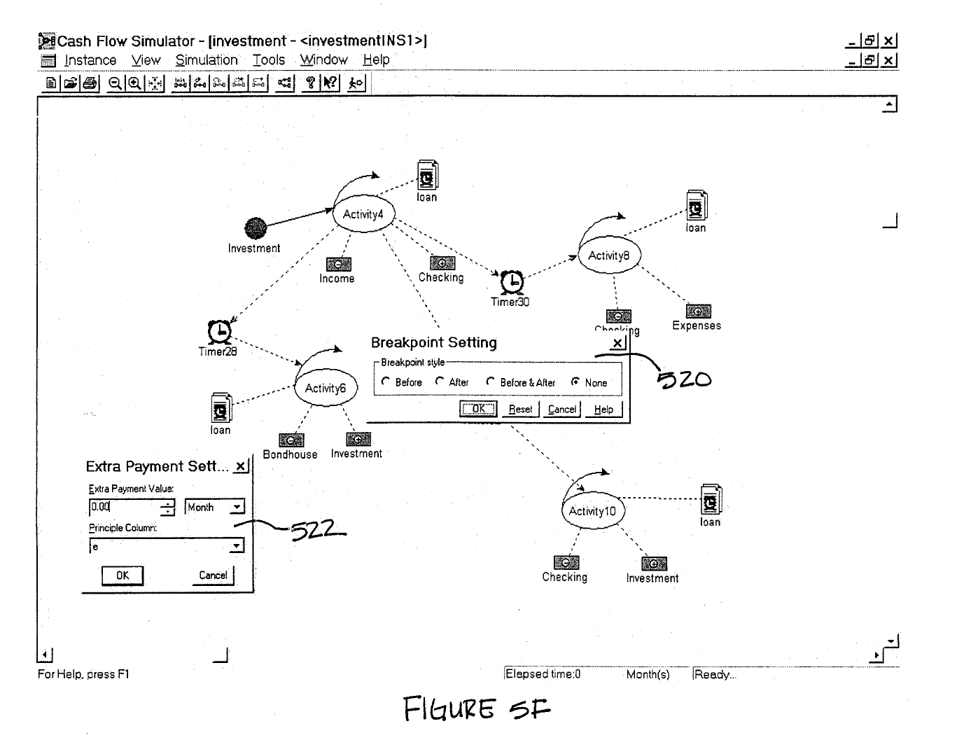

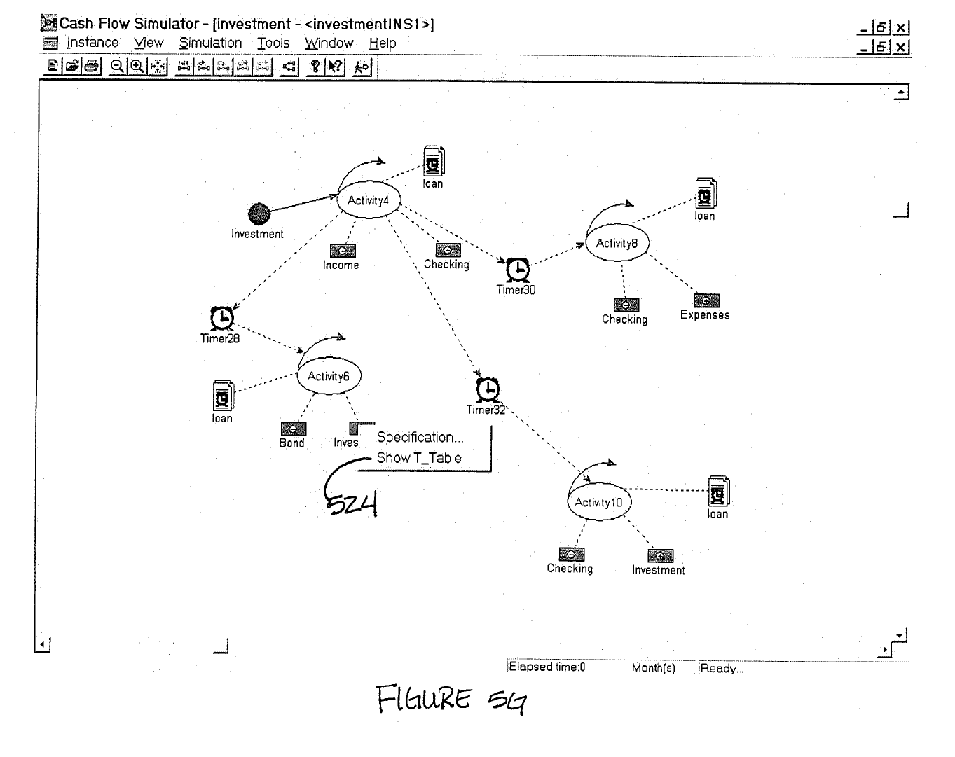

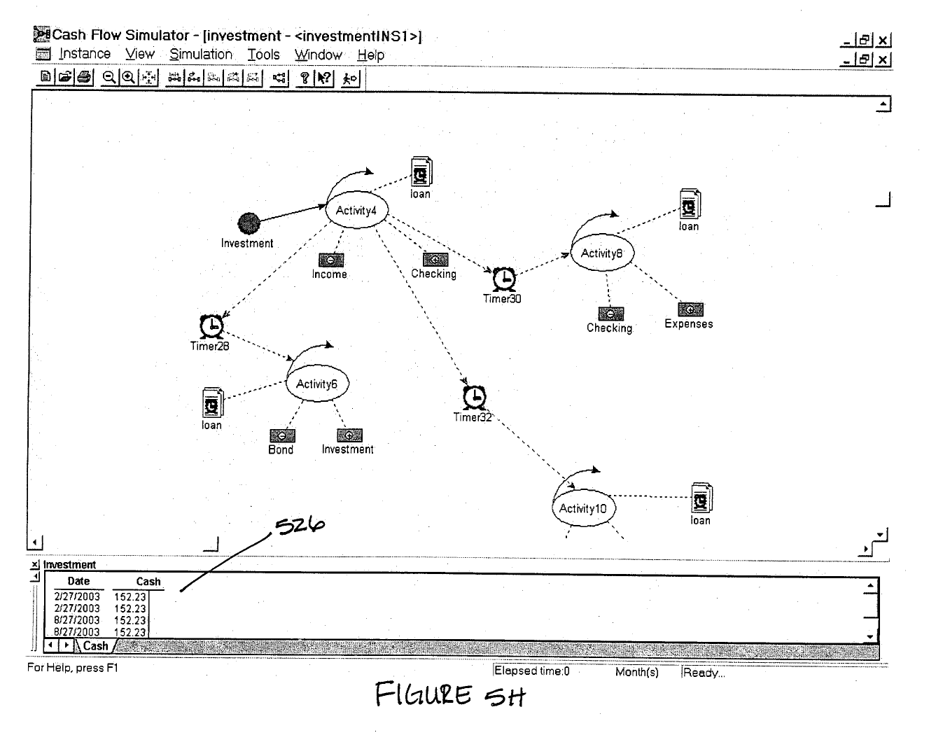

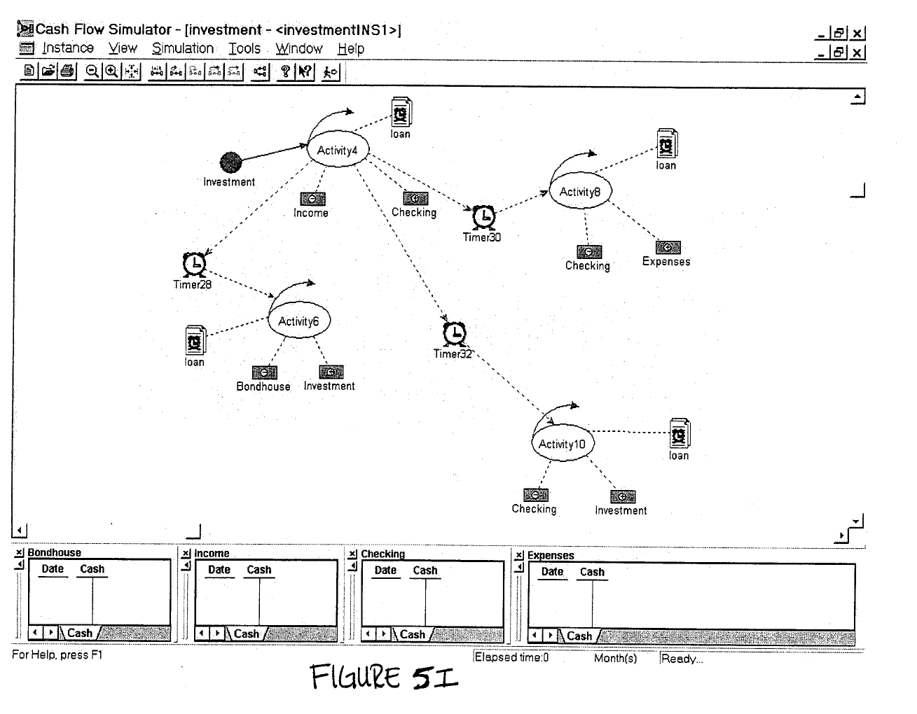

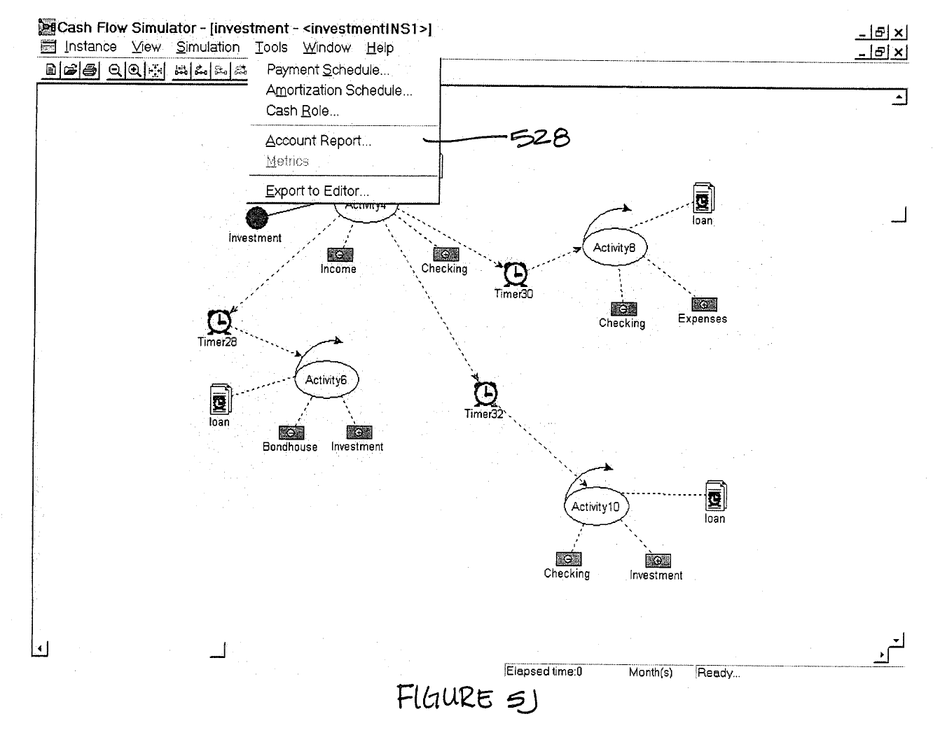

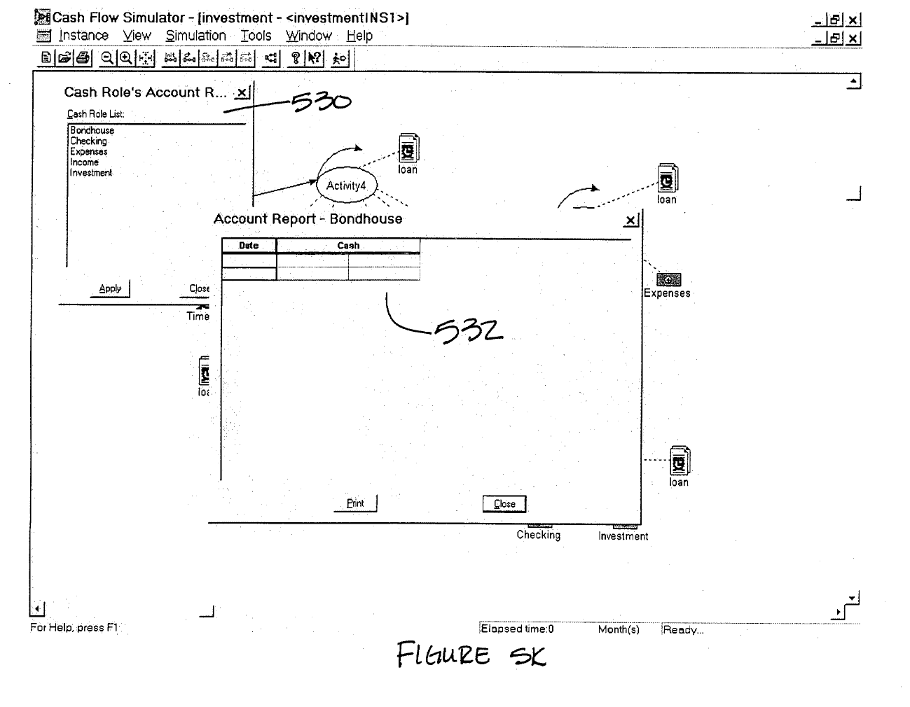

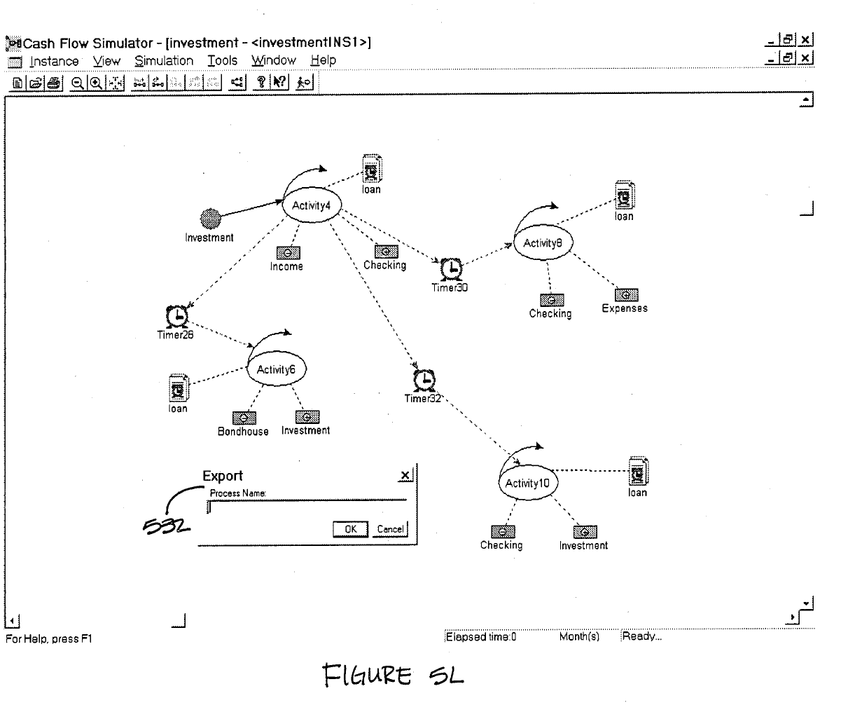

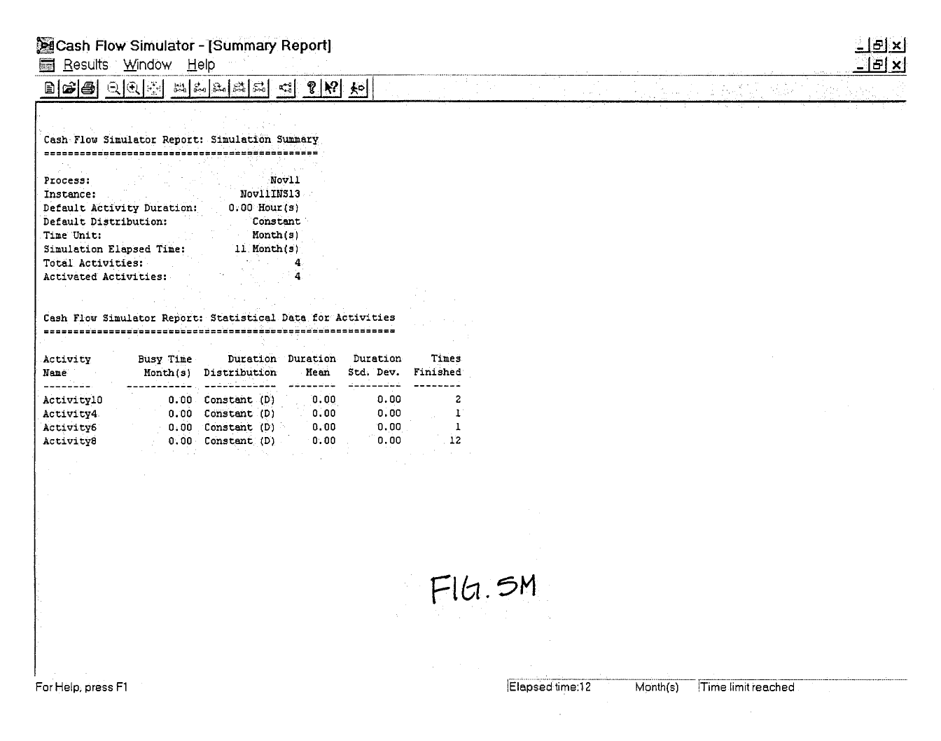

With reference to FIGS. 4 and 5A through 5M, a method for implementing a financial transfer simulator program 400 is presented. Initially at 402, an appropriate screen interface appears when the simulator is started so that the user can load a selected or generated model instance into the executing simulator program. In the depicted embodiment, a simulation instance is a “copy” of the current model as it has been created in a financial transfer editor and as it resides in the common database component 316.

FIG. 5A shows one embodiment of a user interface that appears when a user initially activates a simulator program. The interface includes an “Instance” menu 502 and a “Help” menu 504. The Instance menu 502 has commands for opening existing model instances, creating new model instances, and managing instances such as copying, deleting, and renaming instances. FIG. 5B shows window 506, which appears when the “open” command is invoked, and windows 508/510, which appear when the “create” command is invoked. Similarly, FIG. 5C shows “management” window 512, which appears when the management command is selected. In both the open and management windows, 506, 512, respectively, a list of previously created models appear on the left-hand window side, and a list of instances associated with a selected model appear on the right-hand window side.

Returning back to FIG. 4, in the depicted embodiment, before a user can load an instance, the routine checks to confirm that the model is complete (as defined by the designer) at step 404. If it is not complete, it displays an incomplete model error at 406 and returns back to step 402. Conversely, if the model is complete, the routine proceeds to step 408 and displays to the user the loaded model instance in an appropriate screen (user) interface. FIG. 5D shows such an appropriate screen interface with a loaded, exemplary instance 513. This screen interface has the “Instance” and “Help” menus from the previous interface, along with conventional “View” and “Window” menus and a “Simulation” and a “Tool” menu. These latter two menus and their included commands will be discussed in greater detail herein.

At 410, the routine executes a command that is selected by a user. In general, a user can adjust simulation parameters at 412, execute a selected simulation at 414, display selected simulation results at 416, or edit the loaded model instance at 418. From here, the routine confirms that the user is not exiting the simulator and returns back to step 408 to process a next command from a user. The various commands for performing these options in the depicted embodiment will be discussed in the following sections.

With reference to FIG. 5E, a “simulation” menu 516 with associated simulation commands is shown. The commands include: “Setting,” “Animate,” “Jump to Date,” “Resume,” “Stop,” “Step,” and “Start.” When the “setting” command is selected, window 512 (FIG. 5D) appears. The “Setting” command is used to set the time limit of the simulation. Clicking on the drop menu button to the right of the Time Limit Field displays a selection of time units for the simulation. Simulation results are expressed in the specified time limit. In this embodiment, the choices include: millisecond, second, minute, hour, day, week, month, quarter, or year. The annual discount rate feature is used to calculate money discounting. The default value is zero. In one embodiment, the simulator program records the result of simulation in a Microsoft Access database file. The user can specify the path-name of this file by using the “Change” button. In a simulation result database, there is a table for each cash role in a model. The cash roles and the names of their tables are listed in the Table name list.

With reference to FIGS. 5E through 5I, the remaining commands in the Simulation menu 516 will be discussed together. Once a simulation has begun, changes cannot normally be made to numerical parameters unless the process (model instance) has been initialized. Selecting the “initialize” command initializes the process and allows the user to edit numerical parameters. If the process has not been initialized and the user attempts to modify icon specifications, the specifications will be displayed in read-only mode. When a simulation is running, the Initialize option is ghosted (unavailable). However, users may still make changes to cost and duration values by clicking on the Stop button to halt the simulation and select the Initialize option.

The “start” command starts the process simulation. This menu option is ghosted (unavailable) while the simulation is running. The “step” command allows users to step through activities one at a time. Simulation typically begins and is stopped before the simulation can be stepped through. Each time this menu option is selected, the Simulator program steps forward to the next event, such as when an activity is activated or completed. The “stop” command stops the process simulation. This menu option is ghosted (unavailable) when the simulation is stopped. The “resume” command resumes the process simulation once it has been stopped. This menu option is ghosted (unavailable) when the simulation is running. The “jump to date” command forces the simulation to jump to a specified date. When this menu item is selected, a dialog box such as that indicated at 518 in FIG. 5E will pop-up. With this command option, one can simply enter a date and press OK to jump to a desired part of the simulation. The simulation restarts and stops just before the given date. When jumping, most user interface elements will not refresh as the simulation progresses, so the jumping speed can be faster than normal simulation. Finally, the “animate” command animates the process while the simulation is running by highlighting each activity as it becomes active. Highlighted manual and automatic activities, e.g., turn solid red when triggered.

With reference to FIGS. 5J through 5M, the “Tools” menu 528 commands will now be discussed. In the depicted embodiment, the tools menu includes: a “payment schedule” command, an “amortization schedule” command, a “cash_role” command, an “account report” command, a “metrics” command, and an “export_to_folder” command. The schedule (payment, amortization) commands operate similarly as those in a financial transfer editor. When the user opens an instance in the simulator program, the simulator has access to a graph editor, which enables a user to appropriately modify an instance through either of these commands. It should be noted that in the depicted embodiment, amortization and payment schedule functions are shown. However, in other embodiments, multiple additional schedules such as Salary, Wages, Punch-card Wages, Computer Time, Electricity, Real Estate Rental, Equipment, Bond, Zero coupon bond, Annuity, Dividend, Gain/loss in stock, and other user-defined schedules are included for implementing desired financial transfers. They have pre-defined attributes that can be changed in the simulator program in generally the same way as in an editor program.

The cash role command allows a user to monitor information generated for a desired cash role. In one embodiment, when the cash role command is selected, a window having two items, “specification” and “show T-Table” appears. The specification option allows the user to select a desired cash role, and the show-T-table option, when selected, causes a T-table (similar to those shown at the bottom of FIG. 51) to be displayed for the selected cash role. During simulation, the data in the T-table is dynamically updated.

The “account report” command is used to show an account report for a selected cash role. Invoking this command causes a dialog window as shown in FIG. 5K at 530 to appear. After selection of a cash role and clicking the “apply” button (or left-double clicking a cash role icon), an account report for the selected cash role (such as the one at 532 in FIG. 5K) will be displayed. The left side of the cash column indicates the amount of cash that the role receives and the right side indicates the amount the role pays out. The last row displays the balance of accounts.

The “metrics” command allows the user to generate a report that can be displayed, printed, or written to a file. A sample report is shown in FIG. 5M. Finally, the “export to editor” command is used to export the current instance to create a new process model that can be opened or modified in a financial transfer editor. Clicking this item causes a dialog to pop up as shown in the figures. After entering the process name, the user can click the OK button to create a new process on the basis of a current instance.

2. Example

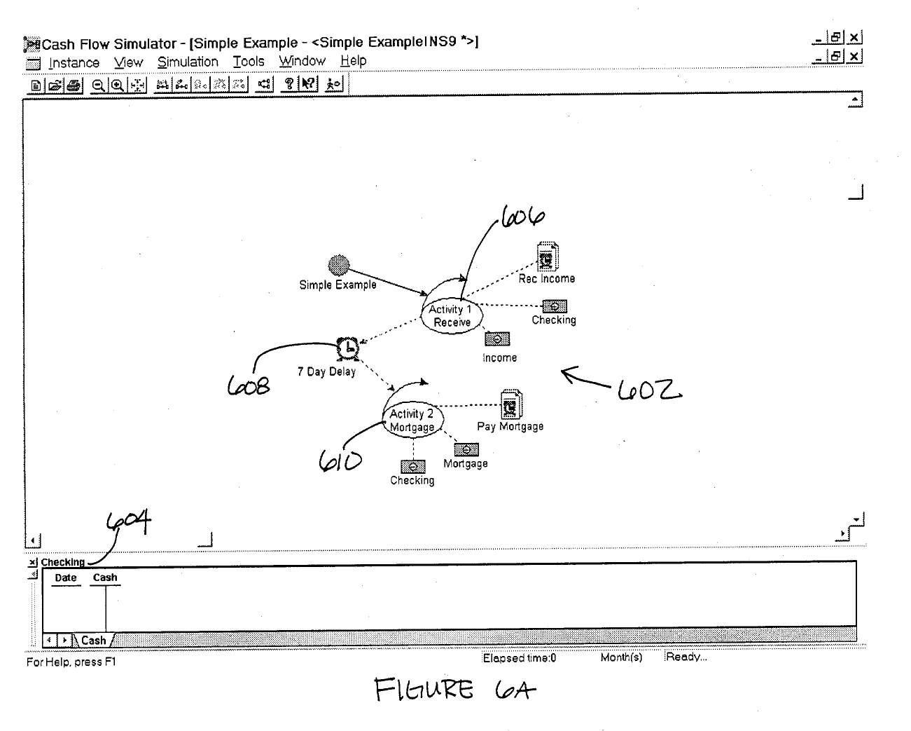

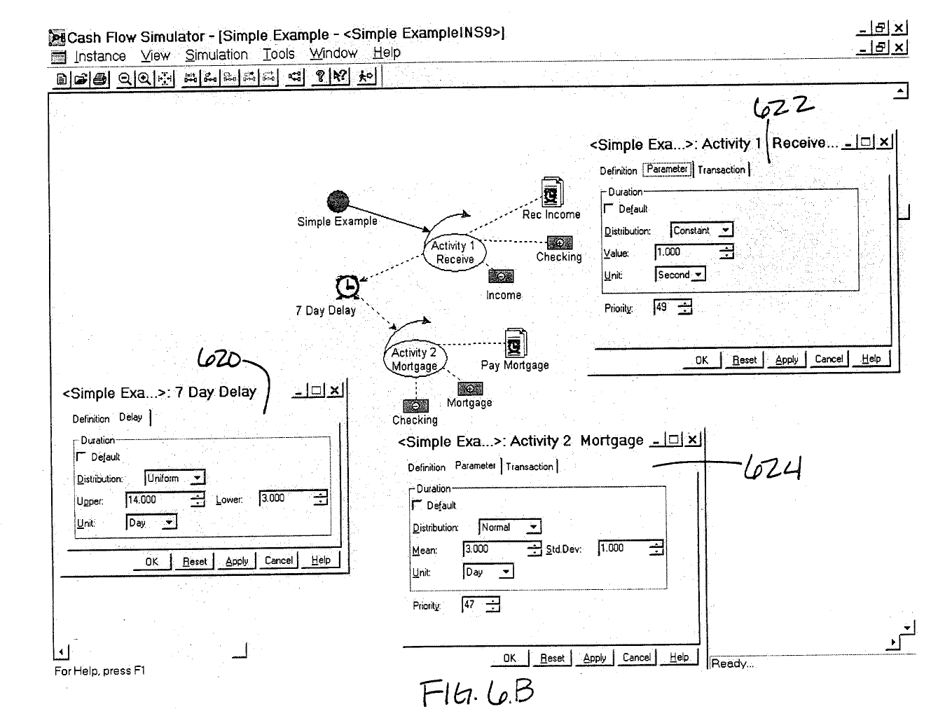

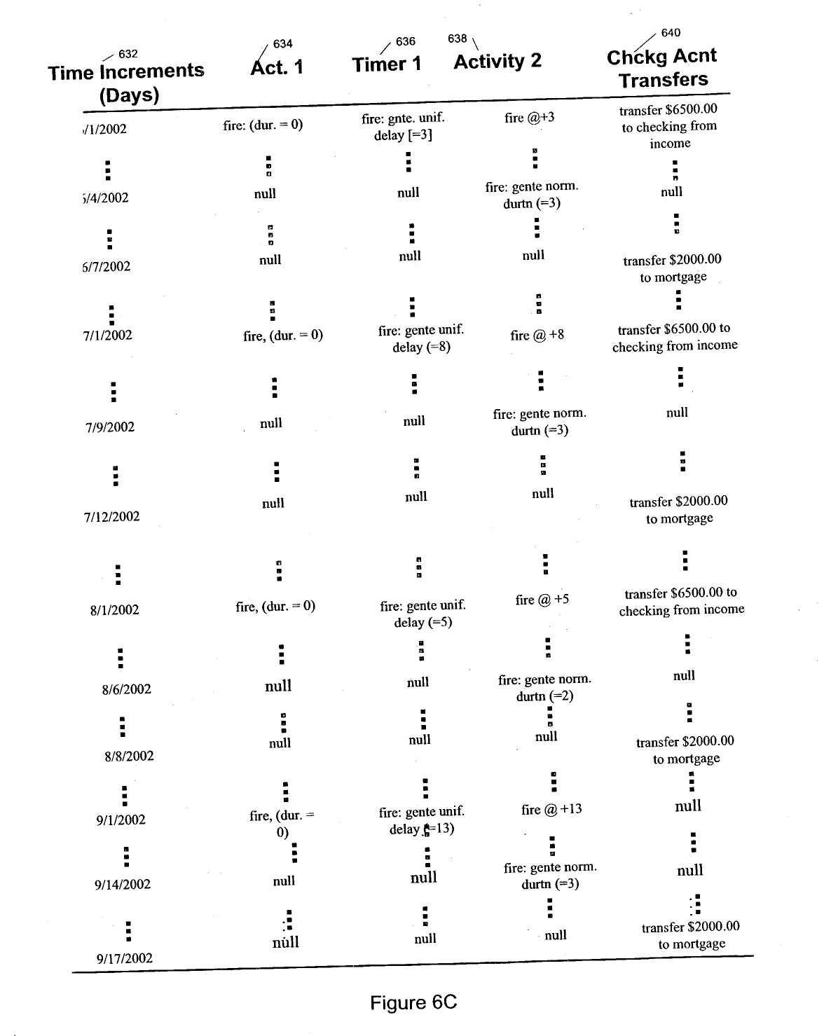

FIGS. 6A, 6B, and 6C show a simple example of a model simulation for a model entitled, “Simple Example” 602. This model corresponds to a home owner receiving its monthly income of $6500.00, depositing it in its checking account, and paying its monthly mortgage payment of $2000.00. Again, this is an extremely simple example, but it illustrates how a financial designer can easily and realistically model and simulate a financial product with a simulator program of the present invention. The simulator allows the various transactions to be modeled taking into account inconsistencies in the timing and amounts of payments that are transferred from one cash role to another. With numerous payers, payees and transactions, this can be highly valuable in determining whether or not a financial product will or will not be sufficiently profitable. As is shown in the figure, the model includes activity 1 606 for modeling receipt of the home income, a delay timer 608 for modeling the time it takes for the money to become available, and activity 2 610 for the mortgage payment. There are three associated cash roles: income, checking, and mortgage. A post-simulation T-table 604 for the checking account cash role is also depicted.

With reference to FIG. 6B, parameter windows 620, 622, and 624 are shown, respectively, for delay timer 608, activity 1 606, and activity 2 610. The delay timer has been specified to impose a uniformly distributed nominal delay of between three and five days. The reoccurring (home income) activity 1 has been set to fire on a monthly basis 1 second after the start cycle occurs. It has effectively been set to consistently fire at the beginning of each month.

Finally, activity 2 (mortgage payment) is set to occur (according to a normal distribution with a mean of 3 and a standard deviation of 1) 3 days after the delay timer has fired. Partial results of the simulation are shown in the T-table at 604 in FIG. 6A. It can be seen that as expected, the checking account receives the income payment on the first of each month, but the mortgage payment is paid out of the checking account over various delays from the beginning of each month based on the behavior of delay timer 608 and reoccurring mortgage payment activity 610.

FIG. 6C is a table illustrating how the discrete event simulation takes place in this example. The table includes a time increment (in days) column 632, a column for tracking actions associated with activity 1 at 634, a column for tracking delay timer activity at 636, a column for tracking actions associated with activity 2 at 638, and a column for showing checking account transfers at 640. Only days where relevant activity occurs are shown.

During the first simulation day (at Jun. 1, 2002), activity 1 fires with a duration of 0. (This corresponds to the constant 1 second delay set in its parameter setting.) This causes the delay timer to fire and generate a delay according to its setting. In this case, a delay of three was randomly generated. In turn, this causes the program to insert a flag in the activity 2 cell to cause it to fire three days from the present time increment. (the “@+3” represents this relative firing time.) The simulation proceeded to the next time increment (Jun. 2, 2002) to check for or establish any actions. Again, however, this time is not shown since nothing occurred here in this simulation example. The simulation then proceeded as shown through each time increment for the pre-specified simulation duration (in this case, four months). Once it ended, values for each activity and cash role were established according to the predefined simulation/model settings and parameters. The values in this table are consistent with the checking account cash role values in T-table 604 in FIG. 6A.

C. Remarks

The present invention in one embodiment provides a financial transfer simulator that enables a user to test and evaluate the behavior of a formally modeled set of cashflows. Any number of recurring and non-recurring cashflows may be specified in a single model thereby enabling financial processes, products, and deals of varying complexity to be described. Unlike conventional simulation tools that require significant expertise and effort, embodiments of a financial transfer simulator can provide feedback to users about the behavior of a set of cashflows without requiring the same levels of expertise and effort. This feedback helps users to learn about the likely behavior of a financial process and to improve the cashflow model until it matches stakeholder requirements and meets performance targets, such as Return on Investment (ROI).

Cashflow models in software programs can handle time-dispersed observations, but they tend to be much less understandable, flexible, and reusable than a simulator of the present invention. No software programming is required to build, test, change, or reuse a cashflow model in such a simulator. Unlike purely descriptive tools like flowcharts or use cases or event trace diagrams, the simulator can enact the model so the user can observe its behavior.

Unlike a simulator program, spreadsheets do not provide any natural way to indicate the source or destination of a cashflow. The modeler must define the roles and accounts, which probably requires duplicating a set of cells and calculations for each role and/or account and adding logic to roll up the detail and summarize the results. Detailed forecasts may warrant this kind of investment, but for preliminary, simple, or one-time models, a financial transfer simulator is much more time-efficient. There is no barrier to cashflow models in software programs being implemented with explicit roles and accounts, but these features add considerable programming overhead. Again, the financial transfer simulator is much more time-efficient. It is not as general as a spreadsheet or accounting program, but it provides a rich set of data for analyzing the set of business problems where cashflows are important.

D. Other Embodiments

Although the present invention and its advantages have been described in detail, it should be understood that various changes, substitutions and alterations can be made herein without departing from the spirit and scope of the invention as defined by the appended claims. Accordingly, the present invention has numerous possible embodiments and should not be limited to those specifically presented in this specification.

We claim as follows:

1. A computer implemented method for simulating a financial transfer model, comprising:
(i) presenting a user with a screen interface that allows the user to load a financial transfer model instance into the executing program;
(ii) writing the model instance into a data structure for performing a discrete event simulation on the model instance; and
(iii) simulating the instance with a discrete event simulation technique using time parameters entered by the user.

2. The method of claim 1, further comprising writing firing values in a simulation table while the simulation occurs.

3. The method of claim 2, wherein the firing values are generated based on predefined user delay settings associated with activities in the model instance.

4. The method of claim 1, further comprising animating financial transfer icons in the model as they fire during the simulation.

5. The method of claim 1, further comprising displaying simulation results for cash roles in the model instance in response to a command from a user.

6. A memory storage device having instructions that when executed by a computer perform the method of claim 1.

7. A simulator program stored on one or more computer-readable memory storage devices for simulating a financial transfer model instance, comprising instructions that when executed by a computer define:
(i) one or more financial transfer graphical user interface components for interfacing the simulator to a user;
(ii) a financial transfer simulator application for performing the financial transfer model simulation; and
(iii) one or more database management components for storing the model instance during simulation.

8. The simulator program of claim 7, further comprising instructions that when executed implement a financial transfer modeling editor application for creating and editing a financial transfer model.

9. The simulator program of claim 7, wherein the simulator application implements a discrete event simulation on a model instance when invoked by a user.

10. The simulator program of claim 7, wherein the graphical user interface components when executed allow a user to modify simulation parameters by clicking on a desired financial transfer activity icon.

11. A method for implementing a financial transfer simulation program, comprising:
(i) providing a user interface for receiving a financial transfer model instance;
(ii) providing command options to a user for specifying simulation parameters and editing the model instance; and
(ii) displaying to the user results of the simulation upon request from the user.

12. The method of claim 11, wherein the simulation parameter command options include a command option for sequentially stepping through a simulation.

13. The method of claim 11, wherein the simulation parameter command options include a command option for animating activity icons while the simulation occurs.

14. The method of claim 11, wherein the simulation parameter command options include a command option for setting the simulation duration.

15. The simulator method of claim 11, wherein displaying the simulation results includes displaying one or more T-tables for cash roles within the model instance.

16. A computer-readable memory storage device having instructions that when executed by a computer perform the method of claim 11.
